(19) United States
(12) Patent Application Publication
(10) Pub. No.: US 2026/0034859 A1
(43) Pub. Date: Feb. 5, 2026

(54) NTERIOR EQUIPMENT OF A VEHICLE AND A METHOD OF MANUFACTURING THE SAME

(71) Applicant: International Automotive Components Group North America, Inc., Southfiled, MI (US)

(72) Inventors: Frank BOLSMANN, Ebersberg (DE); Anton Sebastian DREXLER, Reichertshausen (DE)

(21) Appl. No.: 19/288,077

(22) Filed: Aug. 1, 2025

(30) Foreign Application Priority Data
Aug. 1, 2024 (DE) 102024121921.1

(51) Int. Cl. B60H 1/22; B60R 21/215

(52) U.S. Cl. CPC B60H 1/2227; B60R 21/215; B60R 2021/21537

(57) ABSTRACT

An interior equipment of a vehicle comprises: a flap component covering an airbag module and configured for opening when the airbag is deployed, wherein the flap component comprises a hinge; and a support material attached to at least a border region of the flap component and extending across the hinge. The support material includes at least one conductive fiber extending across the support material and connected to terminals of a power source to pass current through the at least one conductive fiber for heating the support material. Further, the support material is arranged to heat a surface of an interior trim part which is located adjacent to the interior equipment or is part of the interior equipment.

### BACKGROUND

The invention relates to an interior equipment of a vehicle and to a method of manufacturing the same.

An interior equipment of a vehicle, such as a trim part, may include an airbag module that is covered by a flap which is forced open when the airbag deploys. At low temperatures, the material of the flap and its support structure may become brittle. This bears the risk that particles or larger parts of the flap and/or its support structure become loose and flake off when the airbag is deployed explosively.

It is an object of the invention to provide an interior equipment of a vehicle including an airbag module which can be manufactured easily and the operation of which is safe.

### DISCLOSURE

The invention provides an interior equipment of a vehicle and a method of manufacturing the same, as claimed.

According to one aspect, the invention provides an interior equipment of a vehicle comprising a flap component covering an airbag module and configured for opening when the airbag is deployed, wherein the flap component comprises a hinge; and a support material attached to at least a border region of the flap component and extending across the hinge; wherein the support material includes at least one conductive fiber extending across the support material and connected to terminals of a power source to pass current through the at least one conductive fiber for heating the support material. Because the support material is attached to the flap, the support material may be arranged to heat a surface of an interior trim part which is located adjacent to the interior equipment or is part of or is the interior equipment.

According to a further aspect, the invention provides a method for manufacturing an interior equipment of a vehicle, comprising: providing a mold comprising a first mold shell and a second mold shell, which are configured to integrally form a flap component, which closes a passage opening of an airbag, and a hinge section along a side of the flap component; placing a support material into the mold in such a way that a first part of the support material comes to rest on a first surface section of the mold, which is configured to form a surface of the flap component, and a second part of the support material comes to rest on a second surface section of the mold, which is configured to form the hinge, wherein the support material includes at least one conductive fiber extending across the support material and connected to terminals of a power source; closing the mold; introducing plastic material into the closed mold, wherein the first and second parts of the support material are pressed against the first and second surface sections.

Accordingly, the invention makes double or even triple use of the support material known to reinforce the hinge. Such support material increases the tensile strength of the hinge and thus allows safe opening of the flap when the airbag deploys. According to the invention, the support material additionally includes at least one conductive fiber extending across the support material and connected to terminals of a power source to heat the support material. By heating the support material, at least part of the flap and the hinge are heated which makes the flap and the hinge less brittle at low environmental temperatures and improves safe opening of the flap. Additionally, the support material may be arranged to heat a surface of an interior trim part which is located adjacent to the interior equipment or is part of or is the interior equipment to maintain the trim part surface at an agreeable temperature when touched by a passenger of the vehicle.

The invention will be explained below in view of different examples with reference to the drawings

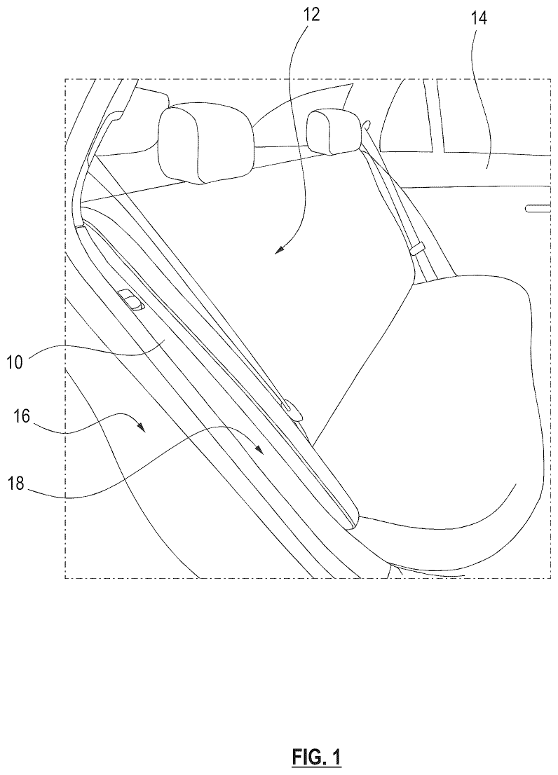

FIG. 1 shows a schematic view of an interior trim part according to an example;

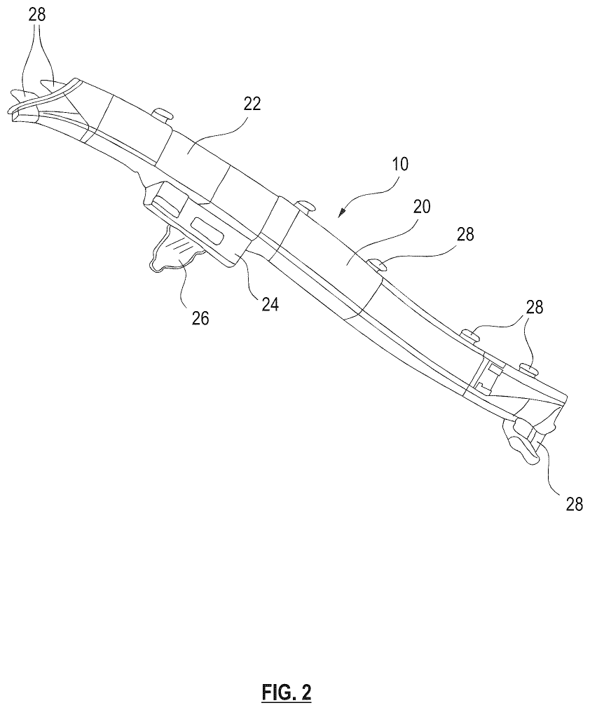

FIG. 2 shows the interior trim part of FIG. 1 when removed from its mounting position;

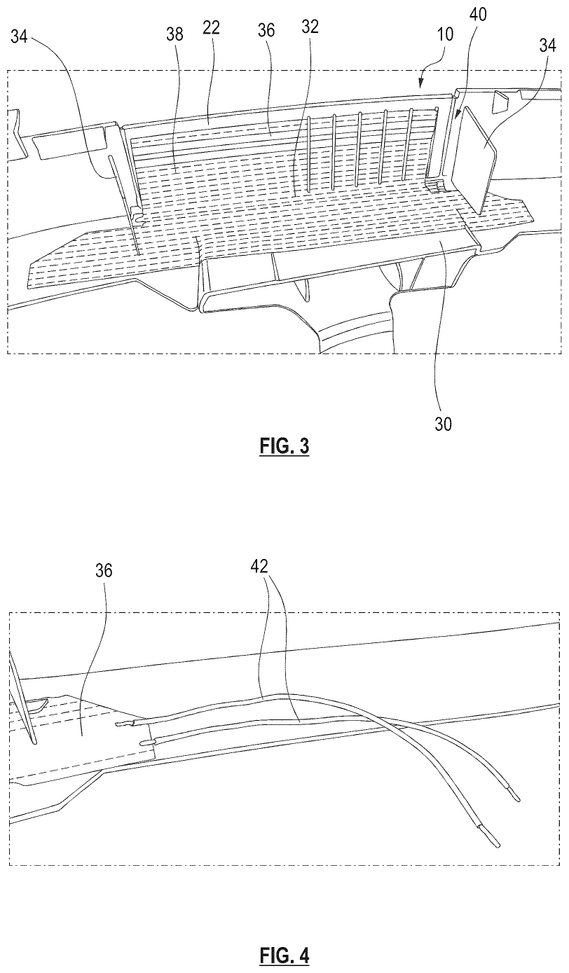

FIG. 3 shows a partial view of the interion trim part of FIG. 2, from inside, according to an example;

FIG. 4 shows another partial view of the interion trim part of FIG. 2, from inside, according to an example;

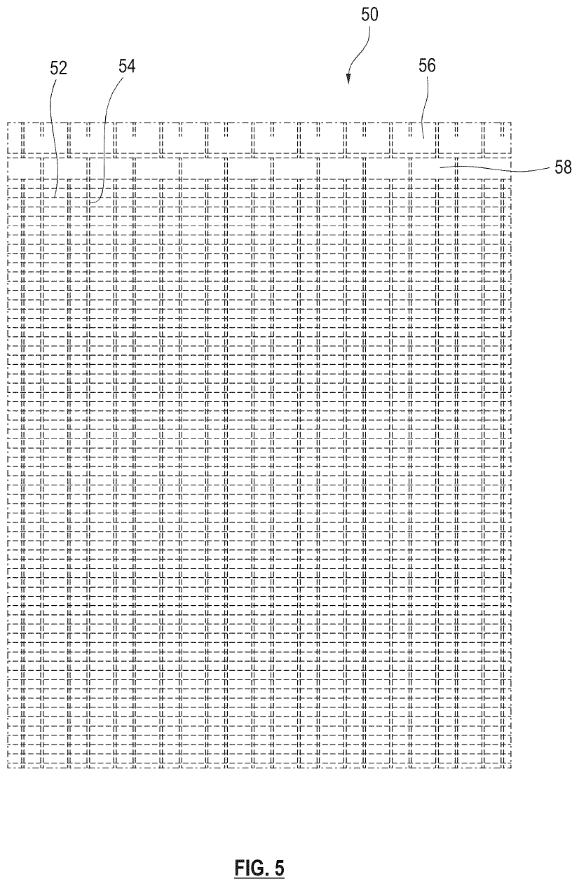

FIG. 5 shows a schematic view of a support material according to an example;

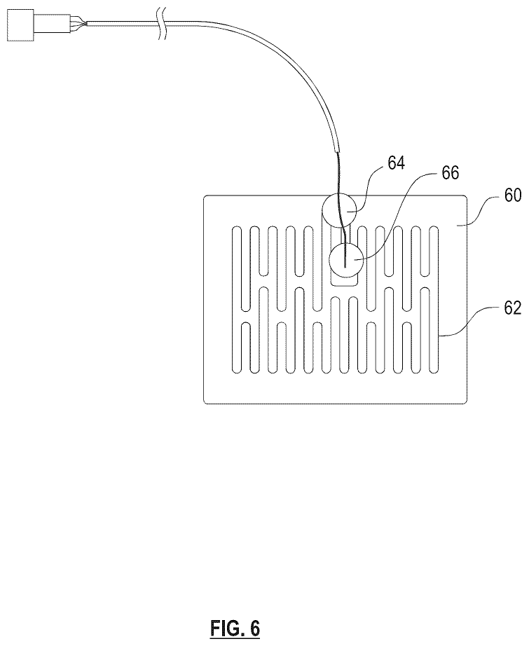

FIG. 6 shows a schematic view of a support material according to another example.

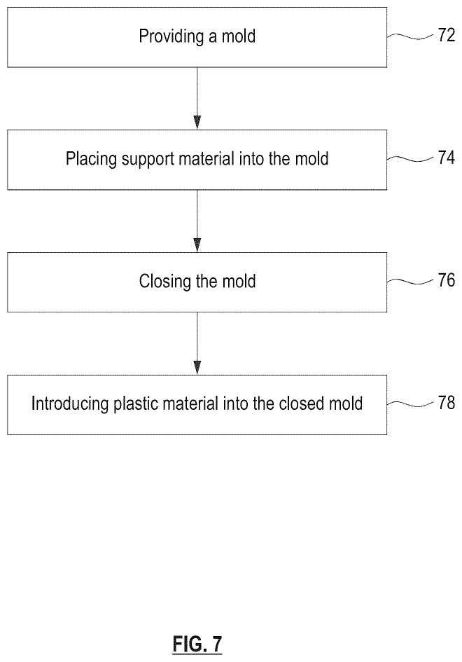

FIG. 7 shows a flow diagram of method of manufacturing the interior equipment, according to an example.

FIG. 1 shows a schematic view of an interior trim part which is an example of an interior equipment of the invention. In this example, the interior trim part is an inner wheelhouse cover 10. In other examples, the interior trim part could be a side column or front column cover, a dashboard cover, a steering wheel cover, a door trim, a storage compartment cover, a knee bolster, a center console cover, or a headliner or a portion thereof, for example.

More specifically, FIG. 1 shows a rear seat arrangement 12 and the inner wheelhouse cover 10 adjacent to the rear seat arrangement 12. Further illustrated in FIG. 1 is a portion of a passenger cabin, including a rear door 14 and a portion of an opposite door opening 16 adjacent to the inner wheelhouse cover 10. FIG. 1 shows an outer surface of the inner wheelhouse cover 10, as an example of a trim part 18, having a hard outer surface. The outer surface of the inner wheelhouse cover 10 may be covered with a textile or foil or slush skin, for example.

FIG. 2 illustrates the inner wheelhouse cover 10 in further detail. As shown in FIG. 2, the inner wheelhouse cover 10 comprises an elongate body 20 covering an airbag cassette (not shown) in which an airbag, an airbag propellant and a chute channel are provided. A flap 22 is integrated in the body 20, the flap 22 covering the chute channel and closing a passage opening for an airbag (not shown). The flap is configured to be forced open when the airbag is deployed explosively. The flap 22 is coupled to the body 20 of the inner wheelhouse cover 10 via a hinge (not shown in FIG. 2). The hinge may be a material weakening and/or a perforation at one side of the flap 22, along the length of the flap 22. FIG. 2 illustrates the flap 22 made from one piece and having an U-shaped. The flap 22 thus has one straight hinge and an opposite U-shaped breaking line terminating at the hinge (not shown in detail in FIG. 2).

The flap shown in FIGS. 2 and 3 is a so-called U-shaped flap because three sides of the flap, defining a U-shaped, are configured as the braking line. Alternatively, the flap could be H-shaped, including two opposite flap portions, with the breaking line defining an H-shape and with two opposite hinges at the outer sides of the H-shape of the flaps.

Further illustrated in FIG. 2 are mechanical connection portions 24 and 26, such as connectors for mounting the airbag module at the vehicle body. Further mechanical connectors 28 are illustrated at two opposite ends and along the length of the inner wheelhouse cassette 10.

The body 20 of the inner wheelhouse cover 10, including the flap 22 and the hinge (not shown in FIG. 2) may be manufactured as an injection molded part. The body 20 of the inner wheelhouse cover 10 may include a frame to support the flap 22 wherein the frame may be connected to the airbag cassette. Similar frames may be provided in other types of interior trim parts.

FIG. 3 shows a partial view of the inner wheelhouse cover 10 of FIG. 2, from inside. More specifically, FIG. 3 shows an inner or rear side of the flap 22 connected to a first side wall 30 of the inner wheelhouse cover 10 via a hinge 32. Opposite to the hinge 32 is the breaking line 40 of the flap 22 where the flap 22 detaches from the inner wheelhouse cover 10 when the airbag deploys. The inner wheelhouse cover 10 further includes chute walls 34 which extend across a width of the inner wheelhouse cover 10. A second side wall opposite to the first side wall 30 is removed in the drawing of FIG. 3 to not obscure the view to the interior of the inner wheelhouse cover 10.

Further shown in FIG. 3 is a support material 36 which is attached to the interior surfaces of the flap 22 and the first side wall 30 and extends across the hinge 32. The support material 36 reinforces the hinge by increasing the tensile strength of the hinge and thus allows safe opening of the flap when the airbag deploys explosively. According to the invention, the support material includes at least one conductive fiber 38 extending across the support material and connected to terminals 42, illustrated in FIG. 4. The terminals 42 allow electrical connection of the support material 36 to a power source (not shown) to heat the support material 36. Further details of the support material 36 are shown in FIGS. 5 and 6. By heating the support material 36, at least part of the flap and the hinge are heated which makes the flap and the hinge less brittle at low temperatures and improves safe opening of the flap. Additionally, the support material 36 is arranged adjacent to the outer surface of the inner wheelhouse cover, in this example at the inner or rear side opposite the outer surface of the inner wheelhouse cover to heat the surface of the inner wheelhouse cover which faces the passenger compartment. It thus is possible to maintain the outer surface at an agreeable temperature when touched by a passenger of the vehicle.

A control unit may be provided to control the power source attached to the at least one conductive fiber 38 to control the temperature generated by the support material. The generated temperature may be in a range of 15° C. to 40° C., more specifically 25° C. to 40° C., or may be at room temperature, i.e. at about 20° C. to 21° C. In another embodiment, the temperature may be in a range from 15° C. to 70° C., such as at approximately 25° C., 40° C., 60° C., or 70° C. According to specifications, the airbag unit is to be operable in the range from −40° C. to +80° C. Heating of the support material 36 ensures safe opening of the flap 22 because it avoids the flap 22 and the hinge 32 from becoming brittle. Additionally, heating of the support material 36 yields an agreeable temperature of the trim part in which the support material and the airbag are integrated, when a passenger touches the trim part.

The support material 36 may be attached to the interior or rear side of the flap 22, at least in a border region thereof bordering the hinge 32, to the hinge 32, and to the interior surface of the sidewall 30 which is bordering the hinge 32 opposite to the flap 22. Attachment may be by glueing, welding, punching, taking, or overmolding, for example. The support material 36 follows the inner contour on the inner surface of the flap 22 and the sidewall 30.

FIG. 5 shows an example of the support material 50. In this example, the support material 50 is a flexible woven material including conductive fibers. In a specific example, the support material includes weft and warp strings 52, 54 which both may include conductive fibers. The fibers are connected in their overlap regions. In this example, every second weft string is connected to a positive bus bar 56 connected to a positive power source terminal, and every other weft string is connected to a negative busbar 58 connected to a negative power source terminal. The material 50 thus forms small rectangles for conducting current therethrough and hence providing a heating effect. One advantage of this configuration is that the support material 50 still can be used as a heating source when it is cut to be adapted to the shape of the flap and the interior trim component.

In a modification of the support material 50 of FIG. 5, one or more nonconductive fibers can be interposed between the conductive fibers to adjust the heating effect of the material. Further, material 50 may be flexible and/or expandable to obtain 3D shapes if necessary.

In another embodiment, the support material 50 is a woven material having first conductive fibers arranged as warp fibers and second conductive fibers arranged as weft fibers. Also in this embodiment, the support material may include first nonconductive fibers, such as

PES fibers, arranged as warp fibers between the first conductive fibers and second nonconductive fibers, such as PES fibers, arranged as weft fibers between the second conductive fibers. Also in this embodiment, there may be two additional weft fibers arranged at the side of the support material as busbar connections.

In other embodiments, the support material may be constructed as described in EP1835786B1 or in EP2736304B1.

FIG. 6 shows another example of the support material 60. In this example, the support material 60 is a nonconductive material, for example from PES fibers. A single conductive fiber 62 is embroidered into the support material 60 and connected at its two ends to positive and negative power source terminals 64, 66. The single conductive fiber 62 may have a serpentine shape covering at least that part of the support material which comes to rest across the hinge and/or the flap border region. The serpentine shape may be arranged such that it covers the largest part of the support material.

In all of the described embodiments, the support material including the conductive fiber(s) may be coated by an insulating material. Additionally or alternatively, the support material may include a scrim part or other fabric attached to a carrier foil. Further, the nonconductive fibers of the support material may be natural and/or synthetic fibers, for example aramid fibers, glass fibers or PES fibers. The conductive fibers may comprise copper, carbon and/or silver.

The support material as such is thin and can be shaped in three dimensions. It can be connected to the interior trim part by over molding, laminating or glueing, for example. In may be cut to shape as needed, without losing the electric conductivity. It can be operated at different voltages and power ranges, such as 12 or 24 or 50V AC or 120V DC and up to e.g. 2000W/m². It heats up quickly and can be isolated by overmolding or by providing additional isolation layer, for example.

FIG. 7 illustrates an example of a method of manufacturing an interior equipment of vehicle as described above. In this example, the interior equipment is an interior trim part having an integrated airbag device, as described above. The method includes providing a mold 72 comprising a first mold shell and a second mold shell, which are configured to integrally form a flap component, which closes a passage opening of an airbag, and a hinge section along a side of the flap component. The flap component may be part of an interior trim part, as shown in FIGS. 2 and 3 wherein the interior trim part, as shown in FIG. 2, may be formed as one piece.

The method further comprises placing a support material into the mold 74 in such a way that a first part of the support material comes to rest on a first surface section of the mold, which is configured to form a surface of the flap component, and a second part of the support material comes to rest on a second surface section of the mold, which is configured to form the hinge. In one example, the support material may be placed into the mold to be located relative to the trim part to be manufactured, as shown in FIG. 3, for example. According to the invention, the support material includes at least one conductive fiber extending across the support material and connected to terminals of a power source to provide heating effect.

In the next step 76, the mold is closed. Thereafter, plastic material is introduced into the mold 78. During this introduction of the plastic material into the closed mold the first and second parts of the support material are pressed against the first and second surface sections, eventually forming the flap and the hinge.

The invention provides a particularly safe interior component including an airbag which can operate safely over a large range of ambient temperatures and additionally can provide a surface of an interior trim part which is very agreeable for a passenger to touch because it will not feel “cold”. Rather, the interior trim part can have an adjustable temperature, corresponding e.g. to room temperature or to body temperature or any other desired temperature.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein.

What is claimed is:

1. An interior equipment of a vehicle, comprising
a flap component covering an airbag module and configured for opening when the airbag is deployed, wherein the flap component comprises a hinge; and
a support material attached to at least a border region of the flap component and extending across the hinge;
wherein the support material includes at least one conductive fiber extending across the support material and connected to terminals of a power source to pass current through the at least one conductive fiber for heating the support material.

2. The interior equipment of claim 1 wherein the support material is arranged to heat a surface of an interior trim part which is located adjacent to the interior equipment or is part of the interior equipment.

3. The interior equipment of claim 1 wherein the support material is attached to the border region of the flap component by glueing, welding, punching, tacking, or overmolding.

4. The interior equipment of claim 1 wherein the support material includes a scrim part.

5. The interior equipment of claim 4 wherein the at least one conductive fiber is woven or embroidered into the scrim part.

6. The interior equipment of claim 1 wherein the support material includes a plurality of conductive fibers arranged in parallel across a width of the support material.

7. The interior equipment of claim 6 wherein the support material is a woven material having first conductive fibers arranged as warp fibers and second conductive fibers arranged as weft fibers.

8. The interior equipment of claim 7, wherein the support material includes first non-conductive fibers arranged as warp fibers between the first conductive fibers and second non-conductive fibers arranged as weft fibers between the second conductive fibers.

9. The interior equipment of claim 8 wherein the support material includes third weft fibers arranged at a side of the support material as bus bar connections.

10. The interior equipment of claim 1, wherein the support material comprises one conductive fiber embroidered into the support material in a serpentine shape.

11. The interior equipment of claim 1 wherein the support material is coated by an insulating material.

12. The interior equipment of claim 1 wherein the support material includes a scrim part or other fabric attached to a carrier foil.

13. The interior equipment of claim 1 wherein the support material includes natural and/or synthetic fibers, in particular, aramid fibers, carbon fibers, glass fibers or PES fibers.

14. The interior equipment of claim 1 wherein the conductive fiber comprises carbon and/or silver.

15. The interior equipment of claim 1 wherein the flap component is further connected to a frame component via the hinge and the support material is further attached to a border region of the frame component.

16. The interior equipment of claim 15 wherein the frame component is attached to an airbag cassette.

17. The interior equipment of claim 1 wherein the flap component and the hinge are embodied as an injection molded part.

18. The interior equipment of claim 1 wherein the support material is expandable at least in a first direction, which extends across the hinge section.

19. The interior equipment of claim 2 wherein the support material is located adjacent to an inner surface of the trim part opposite an outer surface of the trim part facing a passenger compartment of the vehicle.

20. The interior equipment of claim 19 wherein the flap is part of the interior trim part.

21. The interior equipment of claim 1 which is or is part of a side column or a front column, an inner wheelhouse cover, a dashboard, a steering wheel, a door trim, a storage compartment, a knee bolster, a center console, or a headliner.

22. The interior equipment of claim 1 further including a control unit controlling the power source attached to the at least one conductive fiber to control the temperature generated by the support material.

23. The interior equipment of claim 22 wherein the control unit controls the power source to generated a temperature in the range of 15 to 40° C.

24. A vehicle having the interior equipment of claim 1.

25. A method for manufacturing an interior equipment of a vehicle, comprising:
providing a mold comprising a first mold shell and a second mold shell, which are configured to integrally form a flap component, which closes a passage opening of an airbag, and a hinge section along a side of the flap component;
placing a support material into the mold in such a way that a first part of the support material comes to rest on a first surface section of the mold, which is configured to form a surface of the flap component, and a second part of the support material comes to rest on a second surface section of the mold, which is configured to form the hinge, wherein the support material includes at least one conductive fiber extending across the support material and connected to terminals of a power source;
closing the mold;
introducing plastic material into the closed mold, wherein the first and second parts of the support material are pressed against the first and second surface sections.
